(19) United States
(12) Patent Application Publication
(10) Pub. No.: US 2025/0251721 A1
(43) Pub. Date: Aug. 7, 2025

(54) SYSTEM FOR CONTROLLING AT LEAST ONE HYDRAULIC VALVE

(71) Applicant: Continental Automotive Technologies GmbH, Hannover (DE)

(72) Inventor: Martin Griesbeck, Parkstetten (DE)

(73) Assignee: Continental Automotive Technologies GmbH, Hannover (DE)

(21) Appl. No.: 19/048,071

(22) Filed: Feb. 7, 2025

(30) Foreign Application Priority Data
Feb. 7, 2024 (DE) 10 2024 201 104.5

(51) Int. Cl. G05B 19/46; A01B 76/00; F15B 13/04

(52) U.S. Cl. CPC G05B 19/46; F15B 13/04; A01B 76/00

(57) ABSTRACT

A system for the control of at least one hydraulic valve by a user, including a sensor unit located on the body of the user; an evaluation unit, which is communicatively connected to the sensor unit; and a control unit, which is communicatively connected to the evaluation unit. At least one hydraulic valve is communicatively connected to the control unit and is controlled thereby.

### CROSS-REFERENCE TO RELATED APPLICATIONS

The present application claims the benefit and/or priority of German Patent Application 10 2024 201 104.5 filed on Feb. 7, 2024, the content of which is incorporated by reference herein.

### TECHNICAL FIELD

The present invention relates to the control of systems which cause lifting action with liquids. In particular, the present invention relates to a system for controlling at least one hydraulic valve and, accordingly, to a vehicle and a process.

### BACKGROUND

In forestry and agriculture, machines are used in which hydraulic valves for large flows are used. For example, in forestry, timber trailers, forwarders, loading tongs or forestry cranes are used to process or move tree trunks. In agriculture, bale tongs, harvesting machines and round balers are used. All machines often use hydraulically operated elements such as pliers, for example to hold/move large loads. Most machines are operated with simple levers.

Serious accidents occur frequently during this work, especially during loading work. The loading itself, for example of tree trunks, often takes a lot of time. Both are often caused by a limited and non-intuitive operation of the levers, which allow only a few settings (such as “forward”, “back”, and “neutral/zero”). In the worst case, only one lever can be operated at a time or one lever controls exactly one joint of the machine, e.g., the opening/closing mechanism of a pliers.

It can therefore happen that an inexperienced user in a dangerous situation has to think for a long time about which lever leads to defusing the dangerous situation. An experienced user, on the other hand, knows which lever to use. However, valuable time can be lost if only two levers can be operated at the same time (left and right hand) or if it is not possible to use several levers at the same time.

It is the object of the present disclosure to provide a system for controlling at least one hydraulic valve and a vehicle and a method accordingly, which remedy at least one of the previously mentioned disadvantages.

### SUMMARY

The object is met by the subject-matter of the independent claims. Advantageous embodiments of the invention are subject-matter of the dependent claims.

According to a first aspect of the present disclosure, a system for controlling at least one hydraulic valve by a user includes a sensor unit which is located on the user's body. Furthermore, the system includes an evaluation unit, which is communicatively connected to the sensor unit, as well as a control unit, which is communicatively connected to the evaluation unit. The at least one hydraulic valve is communicatively connected to and controlled by the control unit.

A hydraulic valve is a device that controls the flow of fluids in a system in which forces are to be transmitted with the help of fluids. This is achieved by changing the pressure conditions, for example by starting, stopping, or changing the flow of liquid, by opening, closing, or narrowing a passage. The hydraulic valve thus enables the conversion of hydraulic energy into mechanical work.

The sensor unit is used to record a movement desired by the user, such as gripping a plier or the swiveling of a crane, in sensor data. The evaluation unit can then process the sensor data and convert it into a control signal. This can then be forwarded to at least one hydraulic valve to control it.

The advantage of the system described above is that it can be operated from a safe distance. In addition, several hydraulic valves can be controlled intuitively at the same time with the system described, which also has a positive effect on loading times.

In an advantageous embodiment, at least one hydraulic valve is connected to at least one joint of a machine. There are usually other components available to transmit power from the hydraulic valve to a joint, such as a piston rod. A hydraulic valve can also exert a force on several joints at the same time, for example, by means of several piston rods as in the case of pliers.

In an advantageous embodiment, the machine corresponds to one of the following forestry machines: timber trailers, forwarder, loading tongs, or forestry crane. Use in one of these machines can significantly reduce the potential danger, since they handle large and heavy loads.

In an advantageous embodiment, the machine corresponds to one of the following agricultural machines: bale tongs, harvester, mulcher, or round baler.

In an advantageous embodiment, the sensor unit is designed as an oversleeve and/or glove. This results in a particularly intuitive and thus safe and fast input of the control commands by the human user.

In an advantageous embodiment, the sensor unit is formed with at least one pressure sensor and/or at least one accelerometer and/or at least one magnetic sensor and/or at least one gyroscope and/or at least one yaw rate sensor. These sensors are reliable and easily available.

In an advantageous embodiment, the evaluation unit is formed with at least one computer-readable storage medium and a processor. The computer-readable storage medium can serve several purposes, for example, the storage of sensor data from the sensor unit or a computer program product that can evaluate the sensor data. Examples of a computer-readable storage medium are flash memory or solid-state drives. The processor can be designed as a freely programmable electronic circuit, such as an ECU (electronic control unit).

According to a second aspect of the present disclosure, a vehicle includes a system as described above. It should be noted that the system can be designed as a single component. However, it is also possible to implement different parts of the system in different components. For example, the evaluation unit can correspond to an HPC (high performance computer), i.e., a central computer of the vehicle.

The vehicle can be a forestry machine such as a timber trailer, forwarder, loading tongs or forestry crane. However, the vehicle can also correspond to other types, such as a truck, a motor vehicle, a train, an airplane, a helicopter, a bale tong, a harvester, or a round baler.

According to a third aspect of the present disclosure, a method for controlling at least one hydraulic valve by a user includes the following steps:
obtaining sensor data from a sensor unit located on the user's body,
providing a model, where the model correlates the sensor data with pressures for an achievable behavior of at least one hydraulic valve,
generation of an electrical control signal based on the model, and
control of at least one hydraulic valve based on the electrical control signal.

The sensor data is generated with a sensor unit that is worn on the user's body. The sensor unit can be designed, for example, as a glove or sleeve/oversleeve on which one or more sensors are arranged. The sensors are selected and arranged in such a way that they can detect a movement of the user, such as the movement of the fingers and an arm.

In addition, a model is provided that correlates the user's movements in the form of sensor data with how a machine that can be moved by hydraulic valves should behave. For example, the model can be used to define that pliers should be closed when the user's hand is closed. Or that a crane follows the movements of the user's arm. Ultimately, the pressures of the hydraulic valve must be correlated with the behavior to be achieved (closing the pliers, following arm movements), which is conveyed in the form of the sensor data.

In a subsequent step, an electrical control signal is generated for at least one hydraulic valve. This electrical control signal is based on the model, as it correlates the necessary pressure (or pressures) for at least one hydraulic valve to achieve the desired movement entered by the user using the sensor unit.

Subsequently, at least one hydraulic valve is directly or indirectly controlled by means of the electric control signal. It might be necessary to convert the electrical control signal before it is used to actually control the at least one hydraulic valve. This depends on the type of hydraulic valves used, as hydraulic valves can be controlled in different ways, for example, by force (push button, lever, pedal), mechanical (push button, spring, roller), electrically (electromagnet, electric motor), hydraulic or pneumatic, or by complex valves that are a combination of the above mentioned alternatives.

In an advantageous embodiment, the electric control signal is used to control one of or a combination of: a push button, a lever, a spring, a pedal, a roller, an electromagnet, a motor, or a valve.

The procedure carried out by a system as described above allows the control of hydraulic valves and the joints connected to them in a safe and intuitive way.

### BRIEF DESCRIPTION OF THE DRAWINGS

The present disclosure will be further discussed in the following based on example embodiments presented in the attached drawings. However, the present disclosure may be embodied in many different forms and should not be construed as limited to the example embodiments. Rather, the example embodiments are provided for thoroughness and completeness, and fully convey the scope of the present disclosure to the skilled person. The following detailed description refers to the attached drawings, in which:

FIG. 1: A flowchart of an embodiment of a system controlling multiple hydraulic valves;

FIG. 2: A schematic drawing of an embodiment of a vehicle with a system for controlling multiple hydraulic valves; and

FIG. 3: A flowchart of a method for controlling at least one hydraulic valve.

### DETAILED DESCRIPTION

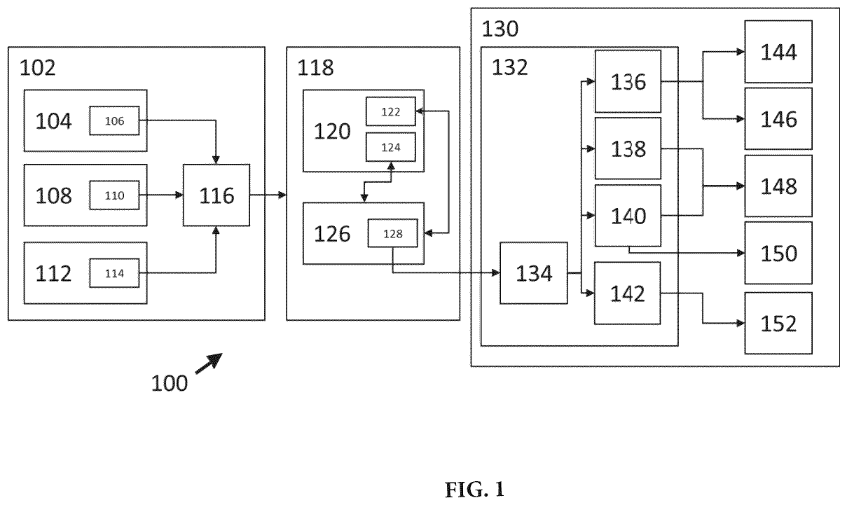

FIG. 1 shows a flowchart of an embodiment of a system 100 for controlling multiple hydraulic valves 136, 138, 140,142.

The system 100 has a sensor unit 102, which in turn has three different sensors 104, 108, 112: a pressure sensor 104, an accelerometer 108, and a magnetic sensor 112. Each sensor 104, 108, 112 generates its own sensor data 106, 110, 114 in the form of pressure sensor data 106, accelerometer data 110, and magnetic sensor data 114. All sensor data 106, 110, 114 are fused to generate fused sensor data 116 in the example of FIG. 1. They are thus merged and processed in such a way that fragmentary and contradictory sensor data 106, 110, 114 represent a homogeneous overall picture. However, it would be possible to use the individual sensor data 106, 110, 114 instead of fused sensor data 116 for further use in the system 100.

The sensor unit 102 can take different forms: a glove, a sleeve or oversleeve, a helmet, or a shirt. Sensors 104, 108, 112 can be of different nature depending on the type of sensor unit 102 and can be arranged accordingly. In the case of a helmet, for example, acceleration sensors 108 can be attached to the front and rear parts to detect a head tilt. In the case of a glove, pressure sensors 104 may be attached to the fingertips to detect when the hand is closed. In general, the sensors 104, 108, 112 are to be arranged in such a way that a movement desired by the user 154, for example a gripping of a pliers or the swiveling of a crane, are recorded in the sensor data 106, 100, 114.

The fused sensor data 116 is now transmitted to an evaluation unit 118. This can be done, for example, wirelessly via UWB (ultra wide band) or Bluetooth. Alternatively or additionally, this may also be realized via any wired connection.

The evaluation unit 118 includes a computer-readable storage medium 120 and a processor 126. A computer program product 124 is stored on the computer-readable storage medium 120, which is designed to perform the steps of a method 160 to control at least one hydraulic valve 136, 138, 140, 142 (see FIG. 3). The computer program product 124 may be available as a digital file, written in a programming language, such as Python or C++.

In addition, a model 122 is stored on the computer-readable storage medium 120. The Model 122 correlates movements of the user 154 in the form of the fused sensor data 116 with a desired behavior of a machine that can be moved by hydraulic valves 136, 138, 140, 142. For example, the Model 122 can be used to define that a pair of pliers should be closed when the hand of the user 154 is closed, or that a crane should follow the movements of the arm of the user 154. For this purpose, the pressures of the hydraulic valves 136, 138, 140, 142 are correlated with the desired behavior (closing the pliers, following arm movements), which is conveyed in the form of the fused sensor data 116.

The processor 126 executes the computer program product 124 stored on the computer-readable storage medium 120 with the addition of the model 122 and calculates the pressures to be set on the hydraulic valves 136, 138, 140, 142 in such a way that the movement entered by user 154 by means of the sensor unit 102 would be carried out. For this purpose, the processor 126 generates an electronic control signal 128.

The electronic control signal 128 is transmitted to a control unit 132 of a forestry machine 130. This is typically done by wire, although wireless transmission is also possible. In the control unit 132, the electronic control signal 128 is received by a signal converter 134, which is responsible for converting the electronic control signal 128 in such a way that it can be processed by the hydraulic valves 136, 138, 140, 142. In the example of FIG. 1, the hydraulic valves 136, 138, 140, 142 are adjusted by an electric motor. The electronic control signal 128 encodes a pressure to be set for each hydraulic valve 136, 138, 140, 142. In signal converter 134, these pressure values are converted into electrical voltages in order to control the electric motors of the hydraulic valves 136, 138, 140, 142. It is also possible that such a signal converter 134 is installed directly in the hydraulic valves 136, 138, 140, 142 and only the corresponding part of the control signal 128 is forwarded to the respective hydraulic valve 136, 138, 140, 142.

The hydraulic valves 136, 138, 140, 142 are now operated according to the specification of the control signal 128. The hydraulic valves 136, 138, 140, 142 are in turn connected to joints 144, 146, 148, 150, 152, often using piston rods 158 to allow power transmission over longer distances. The first and third hydraulic valves 136, 140 are connected to two joints 144, 146; 148, 150, respectively. The third joint 148 is operated by the second and third hydraulic valves 138, 140. The fourth hydraulic valve 142 controls only the fifth joint 152.

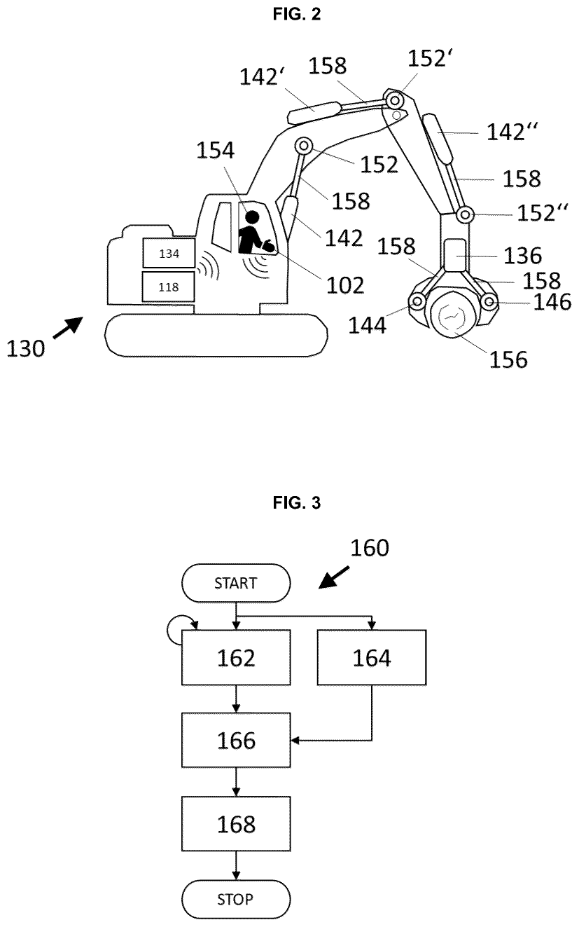

FIG. 2 shows a schematic drawing of an embodiment of a vehicle 130 with a System 100 for controlling several hydraulic valves 136, 142, 142′, 142″.

Vehicle 130 in FIG. 2 is designed as a forestry machine 130, which is used to lift and load a tree trunk 156. For this purpose, a user 154 sits in the forestry machine 130 and is equipped with a sensor unit 102 designed as a glove. The glove can communicate wirelessly with an evaluation unit 118 located in the forestry machine 130, to which it is able to transmit its sensor data 106, 110, 114. The evaluation unit 118 generates an electronic control signal 128 and transmits it to a signal converter 134 in order to convert it into a signal that can be used for hydraulic valves 136, 142, 142′, 142″.

In addition, the forestry machine 130 has the fourth hydraulic valve 142 from FIG. 1, which is connected to a single joint (the fifth joint 152) by means of a piston rod 158. Furthermore, the forestry machine 130 has further fourth hydraulic valves 142′, 142″ and further fifth joints 152′, 152″. With these, a hydraulic valve 142′, 142″ is always connected to exactly one joint 152′, 152″ via a piston rod 158.

The forestry machine 130 also has a first hydraulic valve 136, which is characterized by the fact that it is connected to two, namely the first and second joint 144, 146, via piston rods 158, and can thus open and close a pair of pliers of the forestry machine 130.

The user 154 can now move the hand left/right/up/down, the hand being inside the glove (sensor unit 102). The sensors 104, 108, 112 in the sensor unit 102 detect this movement and transmit the corresponding sensor data 106, 110, 114 to the evaluation unit 118. This identifies the movement and, by means of the model 122, translates it into pressures to be applied to the hydraulic valves 136, 142, 142′, 142″ in order to carry out the movement, which was carried out by the user 154, by the forestry machine 130.

The user 154 can also close his hand in order to grasp the tree trunk 156 with the pliers. In this way, the loading of logs 156 becomes safer and faster.

FIG. 3 shows a flowchart of a method 160 for controlling at least one hydraulic valve 136, 138, 140, 142, 142′, 142″.

In a receiving step 162, which is performed continuously (indicated by the circular arrow in FIG. 3), sensor data 106, 110, 114 from a sensor unit 102 arranged on the body of a user 154 is received.

In a deployment step 164, a model 122 is deployed. The model 122 correlates the sensor data 106, 110, 114 with pressures for a behavior to be achieved of at least one hydraulic valve 136, 138, 140, 142, 142′, 142″.

Now, in a generation step 166, an electric control signal 128 based on the model 122 is generated.

In a control step 168, the at least one hydraulic valve 136, 138, 140, 142, 142′, 142″ is controlled on the basis of the electrical control signal 128.

### REFERENCE SIGNS

| | |
|---|---|
| 100 | System |
| 102 | Sensor |
| 104 | Pressure sensor |
| 106 | Pressure sensor data |
| 108 | Accelerometer |
| 110 | Accelerometer data |
| 112 | Magnetsensor |
| 114 | Magnetic sensor data |
| 116 | Fused sensor data |
| 118 | Evaluation unit |
| 120 | Computer-readable storage medium |
| 122 | Model |
| 124 | Computer program product |
| 126 | Processor |
| 128 | Electrical control signal |
| 130 | Forestry machine |
| 132 | Controller |
| 134 | Signal converter |
| 136 | First hydraulic valve |
| 138 | Second hydraulic valve |
| 140 | Third hydraulic valve |
| 142 | Fourth hydraulic valve |
| 142′, 142″ | Further fourth hydraulic valve |
| 144 | First joint |
| 146 | Second joint |
| 148 | Third joint |
| 150 | Fourth joint |
| 152 | Fifth joint |
| 152′, 152″ | Further fifth joint |
| 154 | User |
| 156 | Tree trunk |
| 158 | Piston rod |
| 160 | Method |
| 162 | Receiving step |
| 164 | Deployment step |
| 166 | Generation step |
| 168 | Control step |

1. A system for controlling at least one hydraulic valve by a user, comprising
a) a sensor unit, which is arranged on a user's body,
b) an evaluation unit, which is communicatively connected to the sensor unit, the evaluation unit comprising a processor and at least one non-transitory computer-readable storage medium, processes sensor data provided by the sensor unit, and generates a control signal based upon the processed sensor data,
c) a controller, which is communicatively connected to the evaluation unit, and
whereby at least one hydraulic valve is communicatively connected to the controller and is controlled thereby based in part upon the control signal.

2. The system according to claim 1, wherein the at least one hydraulic valve is connected to at least one joint of a machine.

3. The system according to claim 2, wherein the machine comprises one of the following forestry machines: forwarder, loading tongs or forestry crane.

4. The system according to claim 2, wherein the machine comprises one of the following agricultural machines: bale tongs, harvester, mulcher or round baler.

5. A system according to claim 1, wherein the sensor unit is configured as at least one of a sleeve or a glove.

6. The system according to claim 1, wherein the sensor unit comprises at least one pressure sensor, at least one accelerometer, at least one magnetic sensor, at least a gyroscope, and/or at least one yaw rate sensor.

7. The system according to claim 1, further comprising software stored in the at least one non-transitory computer-readable storage medium and when executed by the processor, the processor processes the sensor data and generates the control signal.

8. A vehicle comprising the system according to claim 1.

9. A method for control of at least one hydraulic valve by a user, the method comprising:
a) obtaining sensor data from a sensor unit located on a user's body,
b) providing a model, wherein the model correlates the sensor data with pressures for a behavior to be achieved by the at least one hydraulic valve,
c) generating an electrical control signal based on the model, and
d) controlling the at least one hydraulic valve based on the electrical control signal.

10. The method of claim 9, wherein the electrical control signal is used to control at least one of: a push button, a lever, a spring, a pedal, a roller, an electromagnet, a motor, or a valve.

11. The method of claim 9, wherein the sensor unit comprises at least one pressure sensor, at least one accelerometer, at least one magnetic sensor, at least a gyroscope, and/or at least one yaw rate sensor.

12. The method of claim 9, wherein the at least one hydraulic valve is connected to at least one joint of a machine.

13. The method of claim 9, wherein the machine comprises one of the following forestry machines: forwarder, loading tongs or forestry crane.

14. The method of claim 9, wherein the machine comprises one of the following agricultural machines: bale tongs, harvester, mulcher or round baler.

15. The method of claim 9, wherein the sensor unit is configured as part of at least one of a sleeve or a glove.

16. The method of claim 9, wherein the sensor unit comprises at least one pressure sensor, at least one accelerometer, at least one magnetic sensor, at least a gyroscope, and/or at least one yaw rate sensor.

17. The method of claim 1, wherein the evaluation unit receives a model which correlates the sensor data with pressures for a behavior to be achieved by the at least one hydraulic valve, and wherein the control signal is based on the model.
